(19) United States
(12) Patent Application Publication
(10) Pub. No.: US 2022/0292445 A1
(43) Pub. Date: Sep. 15, 2022

(54) WORK ASSISTANCE SYSTEM, WORK ASSISTANCE DEVICE, WORK ASSISTANCE METHOD, AND PROGRAM

(71) Applicant: PANASONIC INTELLECTUAL PROPERTY MANAGEMENT CO., LTD., Osaka (JP)

(72) Inventors: Ayaka NAKAJIMA, Kanagawa (JP); Bilguun SAINBAYAR, Kanagawa (JP); Tetsurou KAKIZAWA, Kanagawa (JP)

(73) Assignee: PANASONIC INTELLECTUAL PROPERTY MANAGEMENT CO., LTD., Osaka (JP)

(21) Appl. No.: 17/638,114

(22) PCT Filed: Jul. 3, 2020
(86) PCT No.: PCT/JP2020/026302

§ 371 Date: Feb. 24, 2022

(30) Foreign Application Priority Data
Aug. 29, 2019 (JP) 2019-156932

(51) Int. Cl. G06Q 10/08

(52) U.S. Cl. CPC G06Q 10/087

(57) ABSTRACT

An object is to increase the efficiency of work in the event of a missing item in a display shelve unit. A work assistance system includes a camera device that captures a goods display shelf and generate a captured image; a missing item detection device that detects an item-missing shelf which is a display shelf where a missing item has occurred based on the captured image, and that generates identification information of the item-missing shelf; and a work assistance device that determines a position of the item-missing shelf based on the identification information of the item-missing shelf and shelf map information indicating an arrangement of the display shelf and that transmits work assistance information including information indicating the position of the item-missing shelf to a terminal.

### TECHNICAL FIELD

The present disclosure relates to a work assistance system, a work assistance device, a work assistance method, and a program.

### BACKGROUND ART

A technique of judging whether an item of goods to be placed in a shelf (hereinafter referred to as “display shelf”) in a store are missing or not by capturing goods in the shelve unit with a camera device and analyzing a captured image is known (Patent document 1).

### CITATION LIST

### Patent Literature

Patent document 1: WO 2019/087519

### SUMMARY OF INVENTION

### Technical Problem

However, Patent document 1 merely relates to detection of a missing item to be placed in a display shelf and does not disclose how to improve the work efficiency in the event of detection of a missing item.

An object of the present disclosure is to provide a technique for improving the efficiency of work in the event of a missing item in a display shelve unit.

### Solution to Problem

A work assistance system according to one mode of implementation of the disclosure includes a camera device that captures a display shelf for goods and generates a captured image; a missing item detection device that detects an item-missing shelf which is a display shelf where a missing item has occurred based on the captured image, and that generates identification information of the item-missing shelf; and a work assistance device that determines a position of the item-missing shelf based on the identification information of the item-missing shelf and shelf map information indicating an arrangement of the display shelf, and that transmits work assistance information including information indicating the position of the item-missing shelf to a terminal.

A work assistance device according to another mode of implementation includes a receiving unit that receives, from a missing item detection device which detects an item-missing shelf that is a display shelf where a missing item has occurred based on a captured image of a display shelf for goods, information relating to the item-missing shelf; a processing unit that determines a position of the item-missing shelf based on the information relating to the item-missing shelf and shelf map information indicating an arrangement of the display shelf, and that generates work assistance information including information indicating the position of the item-missing shelf; and a transmission unit that transmits the work assistance information to a terminal.

A work assistance device according to a further mode of implementation includes a receiving unit that receives a captured image of a display shelf for goods from a camera device; a processing unit that detects an item-missing shelf which is a display shelf where a missing item has occurred based on the captured image, that determines a position of the item-missing shelf based on information relating to the detected item-missing shelf and shelf map information indicating an arrangement of the display shelf, and that generates work assistance information including information indicating the position of item-missing shelf; and a transmission unit that transmits the work assistance information to a terminal.

Each of the above comprehensive or specific modes of implementation may be realized in the form of a system, a device, a method, an integrated circuit, a program, or a recording medium or a combination of desired ones of a system, a device, a method, an integrated circuit, a program, and a recording medium.

### Advantageous Effect of Invention

The disclosure can improve the efficiency of work in the event of a missing item on display shelves.

Further advantages and effects of one mode of implementation of the disclosure will become apparent from the specification and the drawings. Although each of these advantages and/or effects are provided by features disclosed in several embodiments and the specification and drawings, all of them need not always be provided to obtain one or more same features.

### BRIEF DESCRIPTION OF DRAWINGS

FIG. 1 is a diagram showing an example configuration of a work assistance system according to one embodiment.

FIG. 2 is a diagram showing an example configuration of a missing item detection device.

FIG. 3 is a diagram showing an example plane of display of goods of a display shelf.

FIG. 4 example shelf allocation information.

FIG. 5 is a diagram showing an example configuration of a terminal.

FIG. 6 is a diagram showing an example configuration of a work assistance device.

FIG. 7 is a table showing example management information.

FIG. 8 shows an example login UI (user interface) for work assistance services.

FIG. 9 shows an example service menu UI of the work assistance services.

FIG. 10 shows an example missing item information UI.

FIG. 11 shows an example shelf map UI relating to a missing item information service.

FIG. 12 shows an example display shelf UI relating to the missing item information service.

FIG. 13 shows an example shelf map UI relating to a shelf map service.

FIG. 14 shows an example display shelf UI relating to the shelf map service.

FIG. 15 shows an example order history UI.

FIG. 16 shows an example shelf map UI relating to a shelf allocation advice service.

FIG. 17 shows an example shelf allocation advice UI.

FIG. 18 shows an example shelf allocation change UI.

FIG. 19 shows an example a price change UI.

FIG. 20 is a diagram for explaining one example method for detecting shelf tags

FIG. 21 is a diagram for explaining one example method for setting sections.

### DESCRIPTION OF EMBODIMENT

An embodiment of the present disclosure will be hereinafter described in detail by referring to the drawings when necessary. However, unnecessarily detailed descriptions may be avoided. For example, detailed descriptions of already well-known items and duplicated descriptions of constituent elements having substantially the same ones already described may be omitted. This is to prevent the following description from becoming unnecessarily redundant and thereby facilitate understanding of those skilled in the art. The following description and the accompanying drawings are provided to allow those skilled in the art to understand the disclosure thoroughly and are not intended to restrict the subject matter set forth in the claims.

### One Embodiment

### <System Configuration>

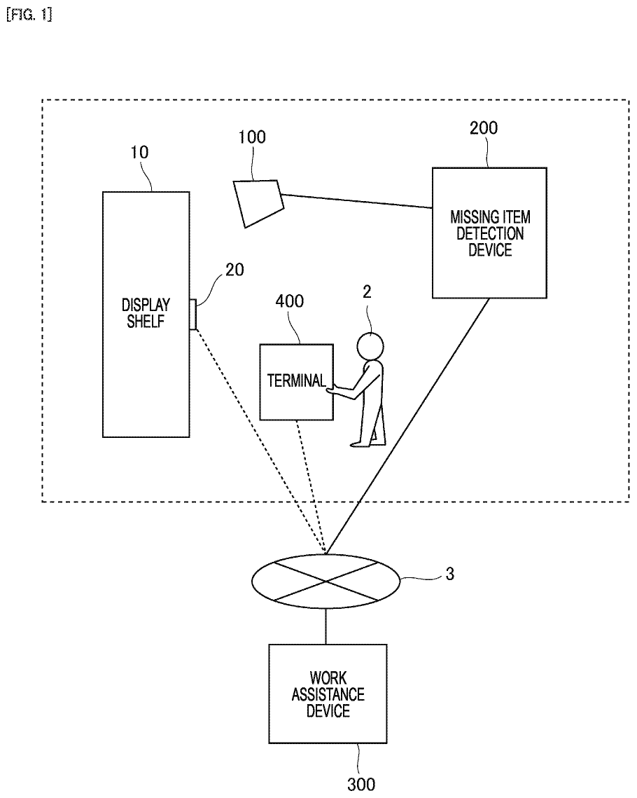

FIG. 1 is a diagram showing an example configuration of a work assistance system according to one embodiment.

This work assistance system is a system of detecting a missing item(s) to be placed in a display shelf(s) 10 disposed in a store and assisting work to be done when a missing item is detected. For example, the store is a supermarket, a convenience store, a department store, a mass retailer, a discount store, a book store, or a concession stand of any of various facilities. Merchandises (examples of articles) to be sold by the store are displayed in the display shelf 10. The display shelf 10 may be disposed not only inside but also outside the store.

Shelf tags 20 each for display of a product name, a price, etc. of each displayed merchandise may be attached to the display shelf 10. Equipped with a liquid crystal display or an electronic paper, each shelf tag 20 is an electronic shelf tag whose display content can be written through a wireless communication. However, in the embodiment, the shelf tag 20 is not limited to an electronic shelf tag and may be a shelf tag in which a display content is printed or hand-written on a paper sheet. The shelf tag 20 may be read as another term such as a shelf card or a shelf label.

The work assistance system is equipped with a camera device 100, a missing item detection device 200, and a work assistance device 300. The work assistance system may also be equipped with a terminal 400. The terminal 400 is carried by, for example, a person (hereinafter referred to as a “person in charge”) who does work relating to missing items. The person 2 in charge is a clerk or a manager of the store in which the display shelf 10 is disposed.

The camera device 100 is installed at such a position as to be able to capture the plane of the display shelf 10 in which goods are displayed. The camera device 100 transmits an image (hereinafter referred to as a “captured image”) obtained by capturing the display shelf 10 to the missing item detection device 200 over a communication network. For example, the communication network is a wired LAN (local area network) or a wireless LAN.

Plural camera devices 100 may be installed in one store or one display shelf 10 may be captured by one display shelf 10. Alternatively, plural display shelfs 10 may be captured by one display shelf 10. As a further alternative, one display shelf 10 may be captured by plural display shelfs 10. The camera device 100 may be a PTZ (pan-tilt-zoom) camera. The camera device 100 may be one that is installed for surveillance of the inside of the store (i.e., surveillance camera). Alternatively, the camera device 100 may be one that is installed for detecting missing items in the display shelf 10.

The missing item detection device 200 detects a display shelf 10 having a missing item (hereinafter referred to as a “item-missing shelf”) by analyzing a captured image that is received from the camera device 100. When detecting an item-missing shelf, the missing item detection device 200 transmits missing item detection information including at least identification information of the item-missing shelf to the work assistance device 300 over a communication network 3. For example, the communication network 3 is the Internet. As shown in FIG. 1, the missing item detection device 200 is installed in the store. Alternatively, the missing item detection device 200 may be installed as a server (e.g., cloud server) that provides a prescribed service via the communication network 3. In this case, the camera device 100 may transmit a captured image to the missing item detection device 200 over the communication network 3.

The work assistance device 300 receives the missing item detection information from the missing item detection device 200 and generates information (hereinafter referred to as “work assistance information”) to be used for assisting work relating to the missing item to be done by the person 2 in charge. The work assistance device 300 transmits the generated work assistance information to the terminal 400 of the person 2 in charge. For example, the work assistance information is information to be used for display of a work assistance UI (user interface). The work assistance device 300 receives instruction information from the terminal 400 and performs processing corresponding to the instruction information. The instruction information is information indicating an instruction that has been input to the terminal 400 by the person 2 in charge. The work assistance device 300 is installed as a server (e.g., cloud server) that provides a prescribed service via the communication network 3.

The work assistance device 300 may transmit, to a shelf tag 20 attached to the display shelf 10 in the store, information (hereinafter referred to as “shelf tag update information”) to be used for updating the display contents of the shelf tag 20. The shelf tag 20 that has received the shelf tag update information updates the display contents based on the shelf tag update information. Examples of the display contents of each shelf tag 20 are a product name and a price and/or POP information. For example, the POP information is sales copy, an explanatory sentence, a discount price, or a discount ratio.

The terminal 400 receives the work assistance information from the work assistance device 300 and displays a work assistance UI based on the work assistance information. Furthermore, the terminal 400 transmits, to the work assistance device 300, instruction information that has been input by the person 2 in charge. For example, the terminal 400 is a tablet, a smartphone, or a PC. The UI that is displayed on the terminal 400 may be a UI that is generated by an application that operates on the terminal 400, based on the work assistance information. Alternatively, the UI that is displayed on the terminal 400 may be a UI that is generated by a web browser that operates on the terminal 400, based on the work assistance information.

### <Configuration of Missing Item Detection Device>

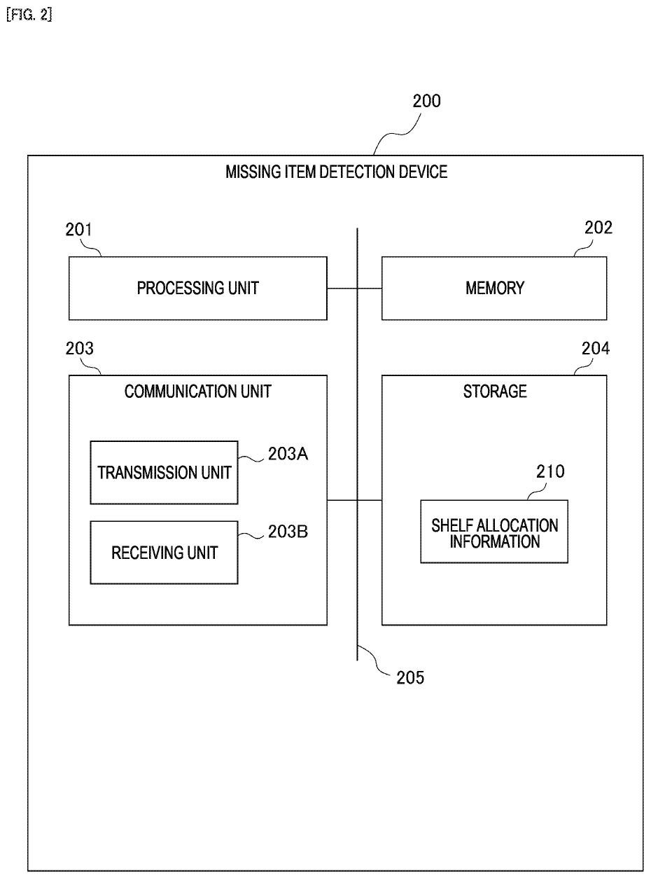

FIG. 2 is a diagram showing an example configuration of the missing item detection device 200. The missing item detection device 200 is equipped with a processing unit 201, a memory 202, a communication unit 203, and a storage 204. The elements 201-204 are connected to each other by an internal bus 205 capable of bidirectional communication. That is, the missing item detection device 200 may be a computer device having a processor and a memory.

The processing unit 201 realizes functions of the missing item detection device 200 by running computer programs. The processing unit 201 may be read as another term such as a processor, a controller, a CPU (central processing unit), or an integrated circuit. In the following description, processing that is mainly performed by the missing item detection device 200 may be read as processing that is mainly performed by the processing unit 201.

The memory 202 stores the computer programs and data relating to the functions of the missing item detection device 200. For example, the memory 202 may be a ROM (read-only memory) or a RAM (random access memory) or a combination thereof.

The storage 204 stores the computer programs and data relating to the functions of the missing item detection device 200. For example, the storage 204 is an HDD (hard disk drive), an SSD (solid-state drive), or a flash memory. The storage 204 may store shelf allocation information 210. The shelf allocation information 210 is information that is used for identification of display shelfs 10 and sections 30.

The communication unit 203 controls transmission to and reception from another device of data via the communication network. The communication unit 203 may include a transmission unit 203A for controlling transmission of data and a receiving unit 203B for controlling reception of data. The communication unit 203 may be read as another term such as a communication interface or a communication module.

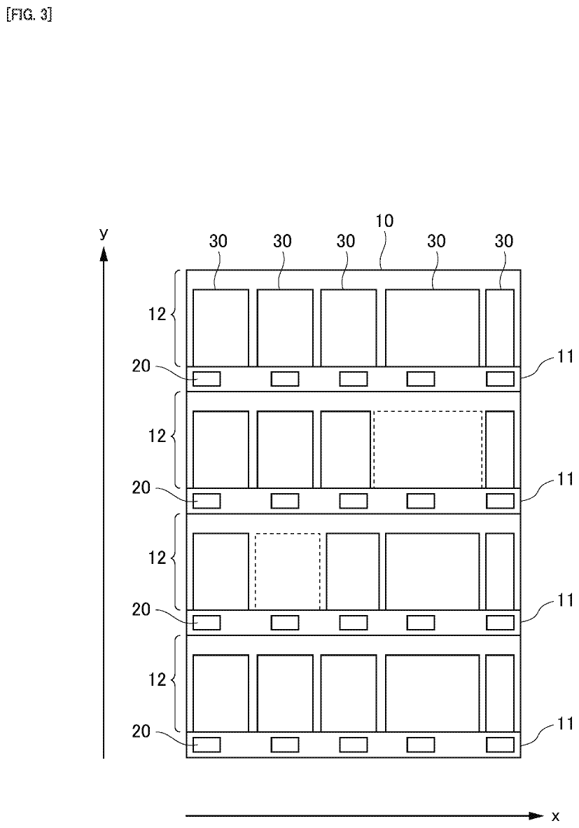

FIG. 3 is a diagram showing an example plane of display of goods of the display shelf 10. Next, with reference to FIG. 3, an example method by which the missing item detection device 200 detects a display shelf 10 where a missing item has occurred.

As shown in FIG. 3, the display shelf 10 is divided into plural display spaces 12 by shelf pates 11. Shelf tags 20 are attached to each shelf plate 11. The same goods corresponding to each shelf tag 20 are displayed in a space located above the shelf tag 20. In the embodiment, the space in which the same goods corresponding to each shelf tag 20 are displayed is referred to as a “section 30.” The missing item detection device 200 sets sections 30 for a captured image of the display shelf 10. Although in FIG. 3 a gap is formed between sections 30, no such gap may be formed. The shape of each section 30 is not limited to a rectangle and may be a polygon, an ellipse, or a circle. Sections 30 may be set manually in a captured image of the display shelf 10. Alternatively, section 30 may be set automatically by the missing item detection device 200. An example in which the missing item detection device 200 sets sections 30 will be described later.

In FIG. 3, sections 30 indicated by broken lines are sections 30 where a missing item has occurred. The missing item detection device 200 analyzes images of the respective sections 30 in a captured image of the display shelf 10 as shown in FIG. 3 and judges whether a missing item(s) has occurred in the display shelf 10.

For example, the missing item detection device 200 is stored with, in advance, an image (hereinafter referred to as a “missing item image”) of each section 30 in which no goods are displayed (i.e., a missing item has occurred) and judges that a missing item has occurred in the display shelf 10 if a missing item is detected in a captured image of the display shelf 10. For example, each missing item image is a background image of the display shelf 10.

The missing item detection device 200 may identify a section 30 (hereinafter referred to as a “item-missing section”) in addition to the camera device 100 where a missing item(s) has occurred (i.e., “item-missing shelf”). In this case, the missing item detection device 200 may include identification information of an item-missing shelf (hereinafter referred to as “item-missing shelf identification information”) and identification information of an item-missing section (hereinafter referred to as an “item-missing section identification information”) in missing item detection information.

Furthermore, the missing item detection device 200 may identify goods that were displayed in the item-missing section (hereinafter referred to as a “missing item”) and have the identification information of the identified missing item (hereinafter referred to as “missing item identification information”) included in the missing item detection information. The missing item detection device 200 may identify a missing item in an item-missing section using shelf allocation information 210 (described later).

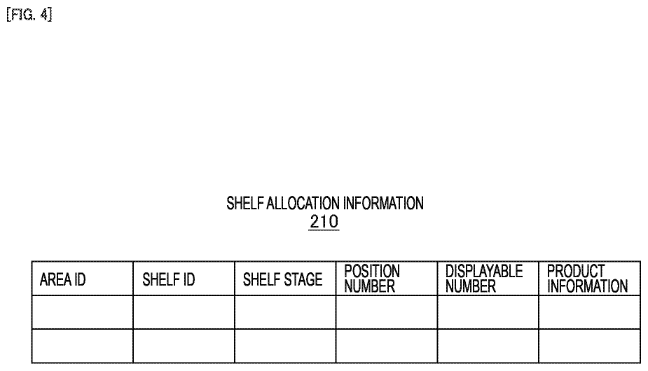

FIG. 4 is a table showing example shelf allocation information 210.

As shown in FIG. 4, the shelf allocation information 210 has items of an area ID, a shelf ID, a shelf stage, a position number, a displayable number, and product information.

The area ID is information for identification of an area of the store.

The shelf ID is information for identification of a display shelf 10 disposed in an area indicated by an area ID.

The shelf stage is information indicating the number of stages as counted from the bottom stage (i.e., information indicating a display space 12). Alternatively, the shelf stage may be information indicating the number of stages as counted from the top stage.

The position number is information indicating the number of sections 30 as counted from the leftmost section in each display space 12 indicated by a shelf stage. Alternatively, the position number may be information indicating the number of sections 30 as counted from the rightmost section in each display space 12 indicated by a shelf stage.

The displayable number is information indicating the number of goods that can be displayed in a section 30 indicated by a shelf stage and a position number.

The product information is information indicating goods that are displayed in a section 30 indicated by a shelf stage and a position number. For example, the product information includes at least one of a product code, a product name, and a price corresponding to the goods.

The shelf stage and the position number of the shelf allocation information 210 are example information (hereinafter referred to as “section identification information”) for identification of a section 30 of a display shelf 10 indicated by a shelf ID. Information that can be used in place of the shelf stage and the position number is coordinates in a display shelf 10. They are values indicating a position itself in the form of, for example, a set of a rightward distance and a downward distance in mm from the origin that is the top-left position of the display shelf 10.

The missing item detection device 200 may determine a shelf ID of a display shelf 10 where a missing item has occurred (i.e., item-missing shelf) by referring to the shelf allocation information 210 and have the determined shelf ID included in item-missing shelf information. Furthermore, the missing item detection device 200 may determine section identification information and a displayable number of a section 30 where a missing item has occurred by referring to the shelf allocation information 210 have the determined section identification information and displayable number included in item-missing section information.

Still further, the missing item detection device 200 may determine product information of missing goods and have the determined product information included in missing item identification information.

### <Configuration of Terminal>

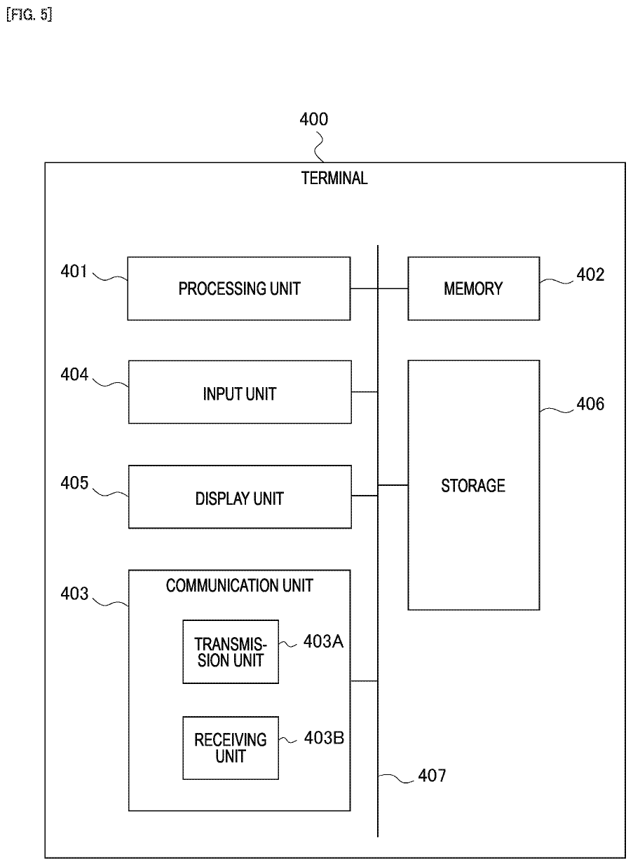

FIG. 5 is a diagram showing an example configuration of the terminal 400. The terminal 400 is equipped with a processing unit 401, a memory 402, a communication unit 403, an input unit 404, a display unit 405, and a storage 406. The elements 401-406 are connected to each other by an internal bus 407 capable of bidirectional communication. That is, the terminal 400 may be a computer device having a processor and a memory.

The processing unit 401 realizes functions of the terminal 400 by running computer programs. The processing unit 401 may be read as another term such as a processor, a controller, a CPU, or an integrated circuit. In the following description, processing that is mainly performed by the terminal 400 may be read as processing that is mainly performed by the processing unit 401.

The memory 402 stores the computer programs and data relating to the functions of the terminal 400. For example, the memory 402 may be a ROM or a RAM or a combination thereof.

The storage 406 stores the computer programs and data relating to the functions of the terminal 400. For example, the storage 406 is an HDD, an SSD, or a flash memory.

The communication unit 403 controls transmission to and reception from another device of data via the communication network. The communication unit 403 may include a transmission unit 403A for controlling transmission of data and a receiving unit 403B for controlling reception of data. The communication unit 403 may be read as another term such as a communication interface or a communication module.

The input unit 404 receives input of a manipulation on the terminal 400. For example, the input unit 404 is an input interface such as buttons, switches, a touch panel, and/or a microphone.

The display unit 405 displays characters, an image, etc. of a UI. The display unit 405 may be read as another term such as a display or a monitor.

### <Configuration of Work Assistance Device>

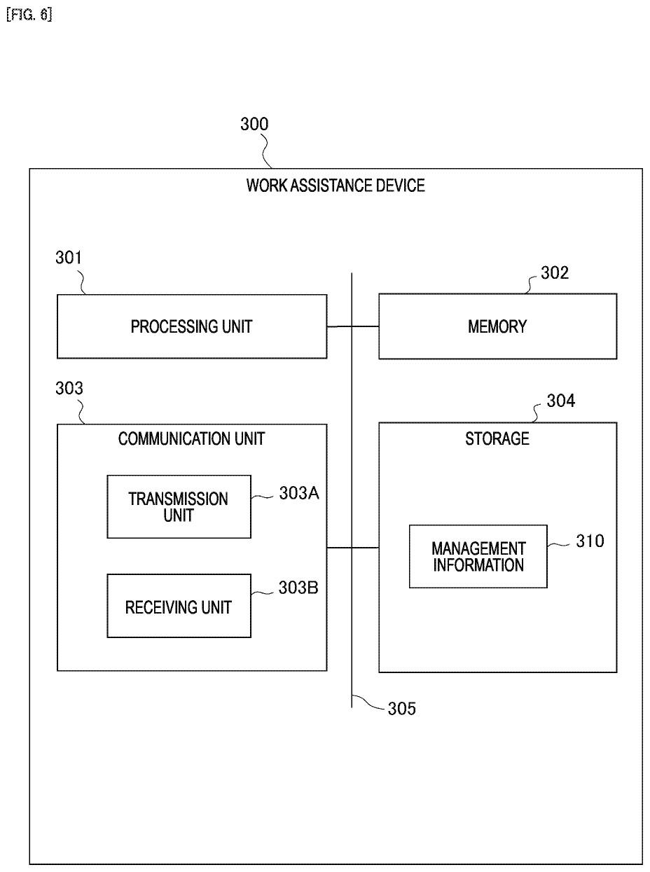

FIG. 6 is a diagram showing an example configuration of the work assistance device 300. The work assistance device 300 is equipped with a processing unit 301, a memory 302, a communication unit 303, and a storage 304. The elements 301-304 are connected to each other by an internal bus 407 capable of bidirectional communication. That is, the work assistance device 300 may be a computer device having a processor and a memory.

The processing unit 301 realizes functions of the work assistance device 300 by running computer programs. The processing unit 401 may be read as another term such as a processor, a controller, a CPU, or an integrated circuit. In the following description, processing that is mainly performed by the work assistance device 300 may be read as processing that is mainly performed by the processing unit 301.

The memory 302 stores the computer programs and data relating to the functions of the work assistance device 300. For example, the memory 302 may be a ROM or a RAM or a combination thereof.

The storage 304 stores the computer programs and data relating to the functions of the work assistance device 300. For example, the storage 406 is an HDD, an SSD, or a flash memory.

The communication unit 403 controls transmission to and reception from another device of data via the communication network. The communication unit 403 may include a transmission unit 403A for controlling transmission of data and a receiving unit 403B for controlling reception of data. The communication unit 403 may be read as another term such as a communication interface or a communication module.

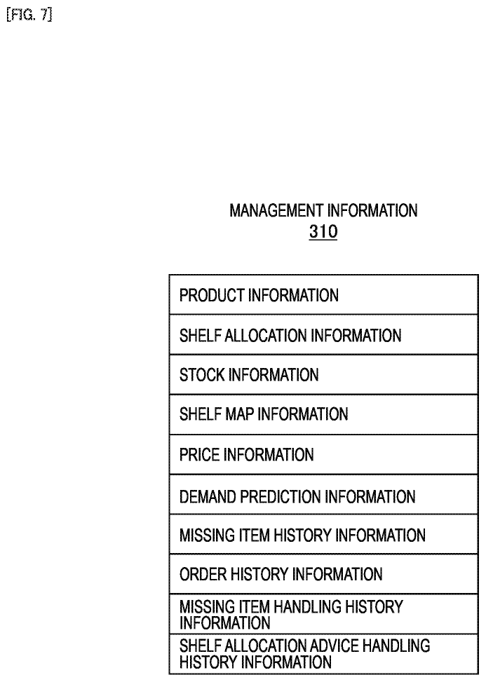

FIG. 7 is a table showing example management information. The work assistance device 300 stores management information 310 to be used for generation of work assistance information in the storage 304. The work assistance information 310 stored in the storage 304 includes at least one of the following pieces of information:

Product information relating to goods;

Shelf allocation information which is information relating to allocation of shelves of each display shelf;

Stock information which is information relating to stock of goods;

Shelf map information which is information relating to arrangement of the display shelf;

Price information which is information relating to prices of goods;

Demand prediction information relating to demand prediction of goods;

Missing item history information which is history information relating to missing items;

Order history information which is history information relating to orders;

Missing item handling history information which is history information relating to handling of missing items; and

Shelf allocation advice handling history information which is history information relating to handling of advice on shelf allocation.

The shelf allocation information that is held by the work assistance device 300 may be the same information as the shelf allocation information 210 shown in FIG. 4 that is held by the missing item detection device 200. Alternatively, the shelf allocation information that is held by the work assistance device 300 may be information that is different at least partially from the shelf allocation information 210 shown in FIG. 4 that is held by the missing item detection device 200. The work assistance device 300 may hold shelf allocation information of each store.

Next, a description will be made of a work assistance service that the work assistance device 300 provides for the terminal 400 of each store.

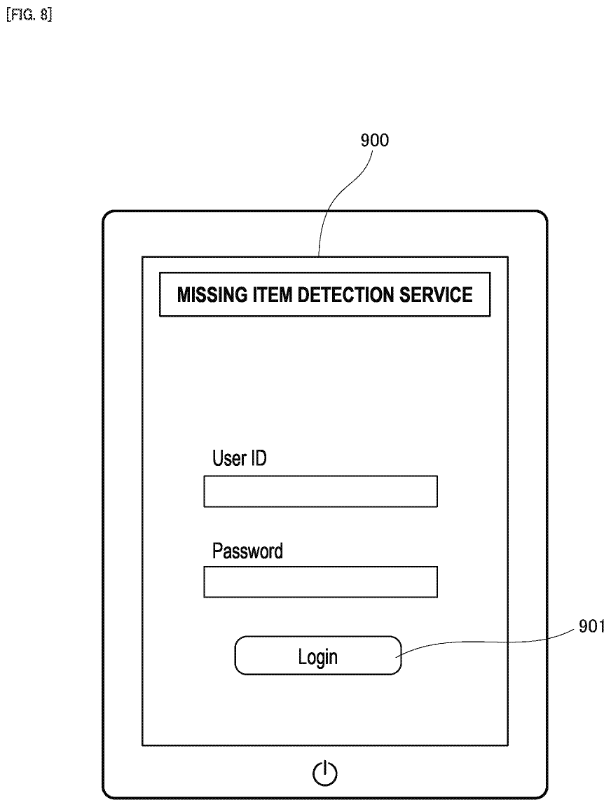

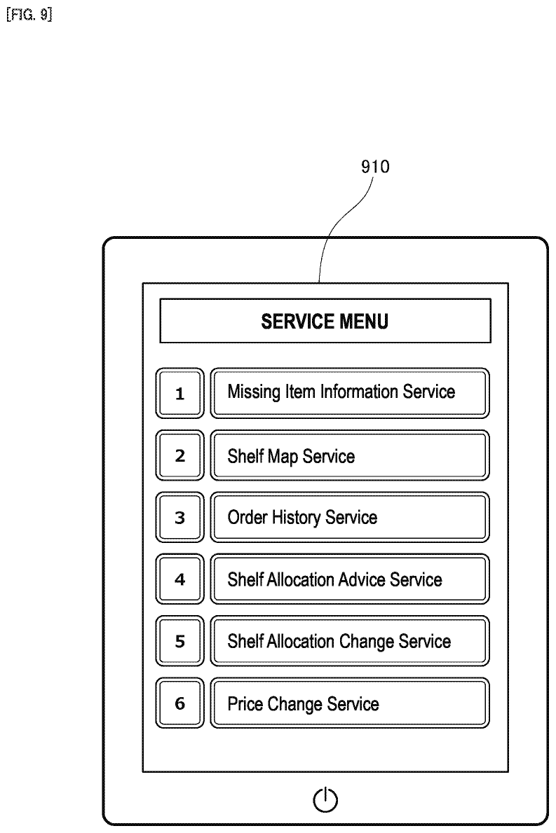

FIG. 8 shows an example login UI for work assistance services. FIG. 9 shows an example service menu UI of the work assistance services.

When accessed by the terminal 400, first, the work assistance device 300 provides the login UI 900 shown in FIG. 8 to the terminal 400. The person in charge 2 inputs a user ID and a password that were assigned to the person in charge 2 in advance to the login UI 900 and pushes a login button 901. If succeeding in authentication of the input user ID and password, the work assistance device 300 provides the service menu UI 910 shown in FIG. 9 to the terminal 400. The word “to push (a button)” as used above in describing the UI can be read as another word such as “touch,” “tap,” “click,” or “select.”

As shown in FIG. 9, the work assistance device 300 provides the following work assistance services:

Missing item information service which provides information relating to a missing item(s);

Shelf map service which provides position information of display shelfs;

Order history service which provides order history information of goods;

Shelf allocation advice service which provides advice information relating to shelf allocation;

Shelf allocation change service for receiving a change(s) in shelf allocation; and

Price change service for receiving a change(s) in a price(s) of goods.

Next, each of the above work assistance services will be described.

### <Missing Item Information Service>

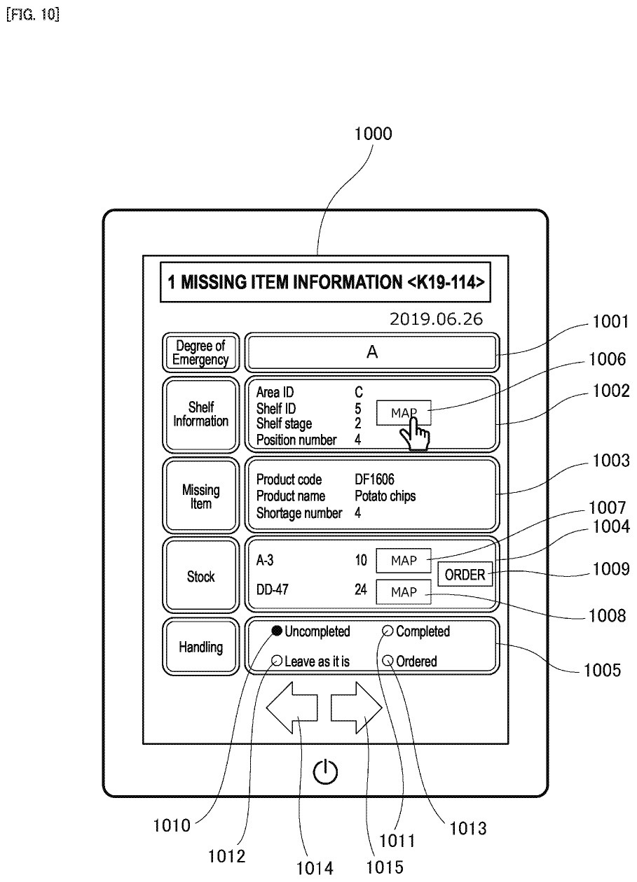

FIG. 10 shows an example missing item information UI. When the missing item information service is selected from the service menu UI 910, the work assistance device 300 provides the missing item information UI 1000 as shown in FIG. 10 to the terminal 400.

The missing item information UI 1000 has a degree-of-emergency region 1001, a missing item shelf information region 1002, a missing item information region 1003, a stock information region 1004, and a handling region 1005.

Information indicating the degree of emergency of replenishment of a missing item (hereinafter referred to as “degree-of-emergency information”) is displayed in the degree-of-emergency region 1001. The degree-of-emergency information may have values “A,” “B,” and “C” (the degree of emergency decreases in this order). The work assistance device 300 may determine the degree of emergency according to a shelf stock number of the missing item, demand information of the missing item, etc. For example, the work assistance device 300 determines the degree of emergency to be “A” if the shelf stock number of the missing item is smaller than a₁, to be “B” if the shelf stock number of the missing item is smaller than a₂, and to be “C” if the shelf stock number of the missing item is smaller than a₃. The numbers a₁, a₂, and a₃ are integers that are larger than or equal to 1 and have a relationship a₁<a₂<a₃. The person in charge 2 can judge the emergency of replenishment of the missing item properly by referring to the degree-of-emergency information. Furthermore, it is a proper action to predict whether the demand increases or decreases due to marketing such as a bargain sale and increases the degree of emergency before a predicted demand increase. That is, there may occur a case that an instruction to replenish a certain kind of goods is made and its degree of emergency is set high (to “A” or “B,” for example) because of a demand prediction even if the number of that kind of goods placed on a shelf has not decreased.

For example, as shown in FIG. 10, an area ID, a shelf ID, a shelf stage, and a position number or information relating to coordinates are displayed as information for identifying an item-missing shelf and an item-missing section. The work assistance device 300 may determine these kinds of information based on missing item detection information received from the missing item detection device 200.

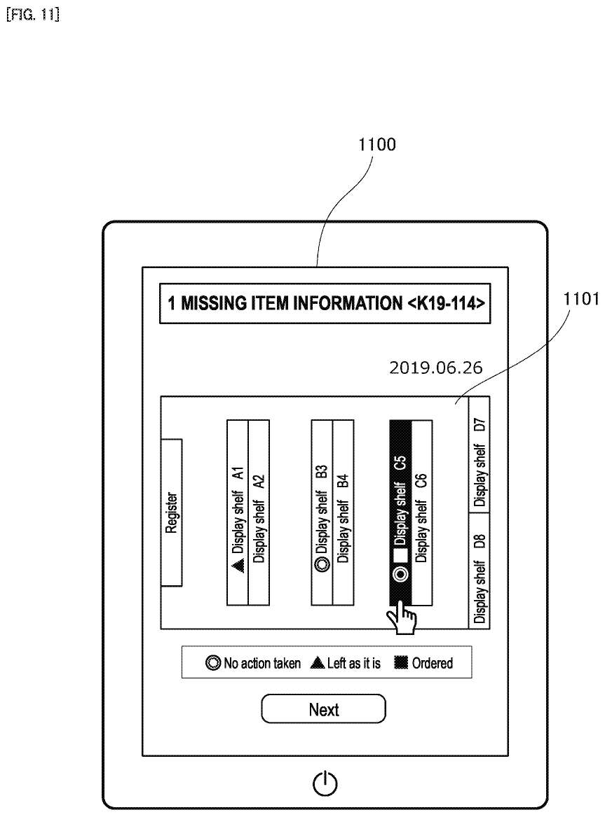

A button 1006 for indicating a position of the item-missing shelf on a map is displayed in the missing item shelf information region 1002. When this button 1006 is pushed, the work assistance device 300 provides the terminal 400 with a shelf map UI 1100 as shown in FIG. 11. The shelf map UI 1100 will be described later (see FIG. 11).

Product information and a shortage number of the missing item are displayed in the missing item information region 1003. The product information includes a product code and a product name. For example, the work assistance device 300 determines product information and a shortage number of the missing item from missing item detection information and demand prediction information received from the missing item detection device 200. A shortage number may be determined based on a displayable number that is included in the missing item detection information. It may be predicted whether the demand increases or decreases due to marketing such as a bargain sale, and a larger shortage number may be set before a predicted demand increase. That is, there may occur a case that replenishment of goods is commanded or a larger shortage number is set based on, for example, demand prediction irrespective of the fact that the number of goods placed on a shelf is not in shortage. In this case, even the shelf allocation may be changed due to increase in shelf stock. The shortage number need not always be an absolute number of goods and may be classified according to the degree of shortage into, for example, groups A (1 to 10), B (11 to 20), and C (21 to 30).

Stock information of the missing item is displayed in the stock information region 1004. As shown in FIG. 10, the stock information may include a first stock position and the number of goods in stock there and a second stock position and the number of goods in stock there. For example, the first stock position is a position that is located in the same area as the display shelf 10 is and the second stock position is a position of a stock shelf that is located in a different area (e.g., store backyard) than the display shelf 10 is. The example of FIG. 10 shows that 10 goods of the missing item exist at the first stock position “A-3” and 24 goods of the missing item exist at the second stock position “DD-47.” The work assistance device 300 determines what number of goods of the missing item are in stock at what stock positions based on, for example, stock information of the store.

As shown in FIG. 10, a button 1007 for displaying the first stock position on a map and a button 1008 for displaying the second stock position on a map are displayed in the stock information region 1004. When the button 1007 or 1008 is pushed, the work assistance device 300 provides a stock position map UI to the terminal 400. The stock position map UI is not shown and may be similar to the shelf map UI 1100 shown in FIG. 11.

A button 1009 for ordering goods of the missing item is displayed in the stock information region 1004. When the button 1009 is pushed, the work assistance device 300 provides the terminal 400 with a UI (not shown) for ordering goods of the missing item.

Buttons for selecting an action to be taken about the missing item. For example, as shown in FIG. 10, an “uncompleted” button 1010, a “completed” button 1011, a “leave as it is” button 1012, and an “ordered” button 1013 are displayed in the handling region 1005. If an action to be taken about the missing item has not been completed, the person in charge 2 may select the “uncompleted” button 1010. If an action to be taken about the missing item has been completed, the person in charge 2 may select the “completed” button 1011. If no action needs be taken about the missing item, the person in charge 2 may select the “leave as it is” button 1012. If goods of the missing item have already been ordered, the person in charge 2 may select the ordered” button 1013. The work assistance device 300 records information indicating the action corresponding to a selected button as missing item handling history information.

A missing item occurrence ID for identification of the occurrence of the missing item may be displayed in the missing item information UI 1000. “K19-114” shown in FIG. 10 is an example display of the missing item occurrence ID.

In FIG. 10, a leftward arrow button 1014 and a rightward arrow button 1015 are buttons for switching to display of missing item information UI 1000 corresponding to another missing item occurrence ID. For example, when the leftward arrow button 1014 is pushed, the work assistance device 300 provides the terminal 400 with a missing item information UI corresponding to a preceding missing item occurrence ID. When the rightward arrow 1015 is pushed, the work assistance device 300 provides the terminal 400 with a missing item information UI corresponding to a following missing item occurrence ID.

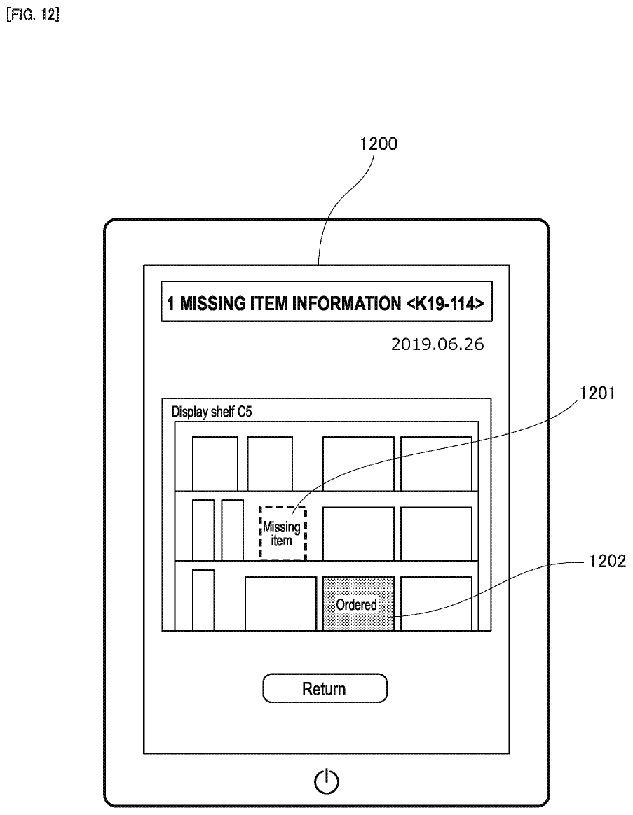

FIG. 11 shows an example shelf map UI relating to the missing item information service. FIG. 12 shows an example display shelf UI relating to the missing item information service. When the button 1006 in the missing item shelf information region 1002 of the missing item information UI 1000 is pushed, the work assistance device 300 provides the terminal 400 with a shelf map UI 1100 as shown in FIG. 11.

A shelf map indicating an arrangement of display shelfs 10 in the store and an image indicating item-missing shelfs are displayed in the shelf map UI 1100. For example, item-missing display shelfs are displayed in such a manner as to be able to be discriminated from the other display shelf 10 (e.g., in a different color).

Information indicating an action that has been taken about a missing item in each display shelf 10 is displayed in the shelfs map UI 1100. For example, as shown in FIG. 11, a double circle mark may be displayed for a display shelf 10 in which no action has been taken yet about a missing item, a black triangle mark may be displayed for a display shelf 10 in which an action that has been taken about a missing item is “leaving it as it is,” and a black square mark may be displayed for a display shelf 10 in which an action that has been taken about a missing item is “ordered.” The marks shown in FIG. 11 are just examples and marks that are different from them may be displayed.

If the person in charge 2 selects an item-missing shelf from the shelfs map UI 1100, the work assistance device 300 provides the terminal 400 with a display shelf UI 1200 corresponding to the selected item-missing shelf. As shown in FIG. 12, the display shelf UI 1200 is a simulated version of the display shelf 10. Alternatively, the display shelf UI 1200 may be one obtained by using an image of the display shelf 10 captured by the camera device 100.

In the display shelf UI 1200, an item-missing section 1201 may be displayed in a different manner than the other sections 30 (e.g., in a different color). In the display shelf UI 1200, an item-missing section 1202 in which goods of the missing item have already been ordered may be displayed in a different manner than the other sections 30 (e.g., in a different color).

The person in charge 2 can check information relating to a missing item efficiently by using the missing-item information service. When receiving missing item detection information from the missing item detection device 200, the work assistance device 300 may provide missing item information UI 1000 to the terminal 400 by push notification. This allows the person in charge 2 to recognize a missing item and an item-missing shelf immediately upon its occurrence and hence to take an action about it quickly.

### <Shelf Map Service>

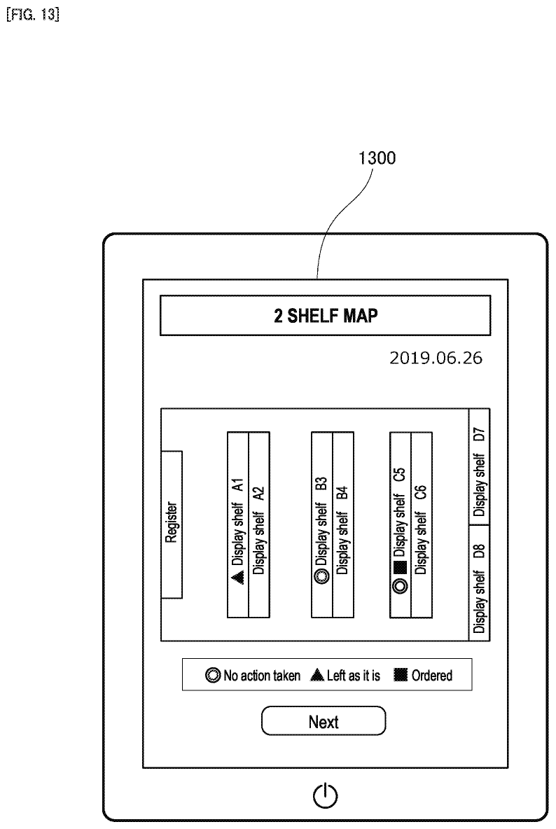

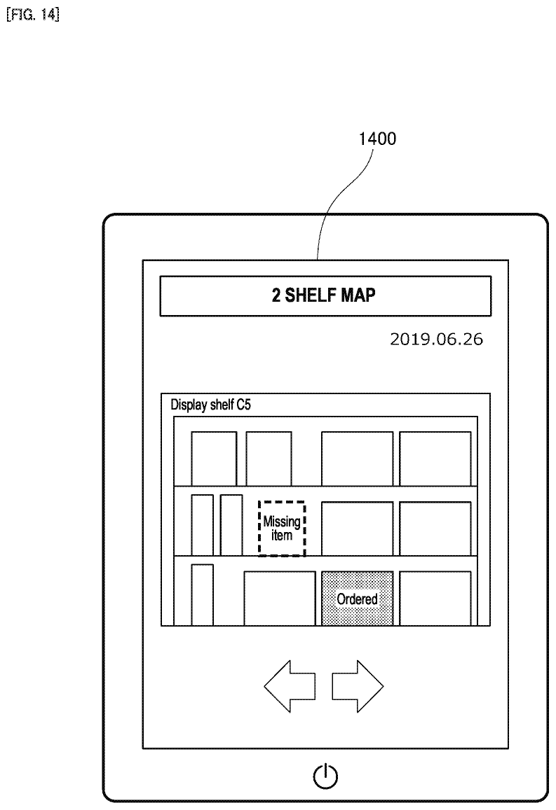

FIG. 13 shows an example shelf map UI relating to the shelf map service. FIG. 14 shows an example display shelf UI relating to the shelf map service. When the shelf map service is selected from the service menu UI 910, the work assistance device 300 provides the terminal 400 with a shelf map UI 1300 as shown in FIG. 13.

In the shelf map UI 1300, if an item-missing shelf(s) exists, the item-missing shelf may be displayed in a different manner than the display shelf 10 without any missing item (e.g., in a different color). The shelf map UI 1300 is not described in detail here because it is approximately the same as the shelf map UI 1100 which was described above with reference to FIG. 11.

If the person in charge 2 selects a display shelf 10 from the shelf map UI 1300, as shown in FIG. 14 the work assistance device 300 provides the terminal 400 with a display shelf UI 1400 corresponding to the selected display shelf 10.

If an item-missing shelf section exists in the display shelf UI 1400, it may be displayed in a different manner than the other sections 30 (e.g., in a different color) as in the case shown in FIG. 12. If an item-missing shelf section in which goods of the missing item have already been ordered exists in the display shelf UI 1400, it may be displayed in a different manner than the other sections 30 (e.g., in a different color) as in the case shown in FIG. 12. The display shelf UI 1400 is not described in detail here because it is approximately the same as the display shelf UI 1200 which was described above with reference to FIG. 12.

The person in charge 2 can check an item-missing shelf visually on the shelf map by using the shelf map service.

### <Order History Service>

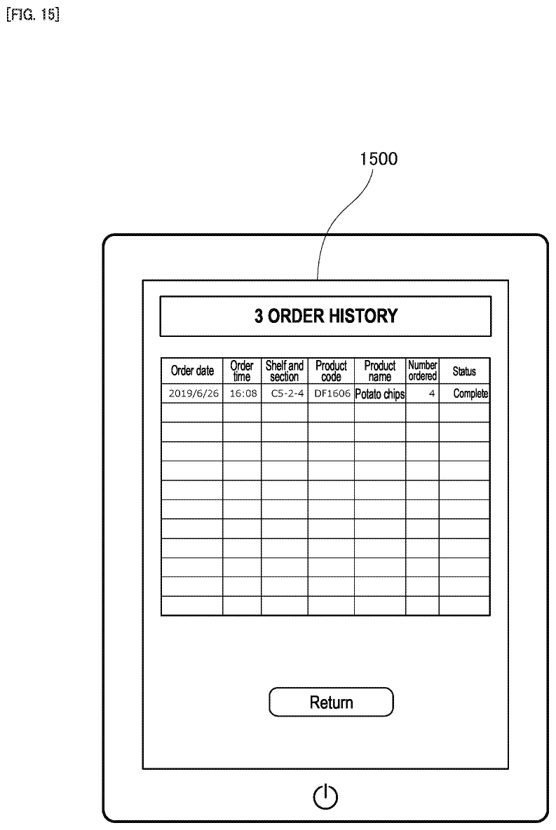

FIG. 15 shows an example order history UI. When the order history service is selected from the service menu UI 910, the work assistance device 300 provides the terminal 400 with an order history UI 1500 as shown in FIG. 15.

An order date, an order time, pieces of identification information of an item-missing shelf and an item-missing section, a product code, a product name, a number ordered, and a status of the order are displayed in the order history UI 1500 for each ordered product. The work assistance device 300 may generate an order history UI 1500 based on order history information.

The person in charge 2 can easily check history information orders for a missing item by using the order history service.

### <Shelf Allocation Service>

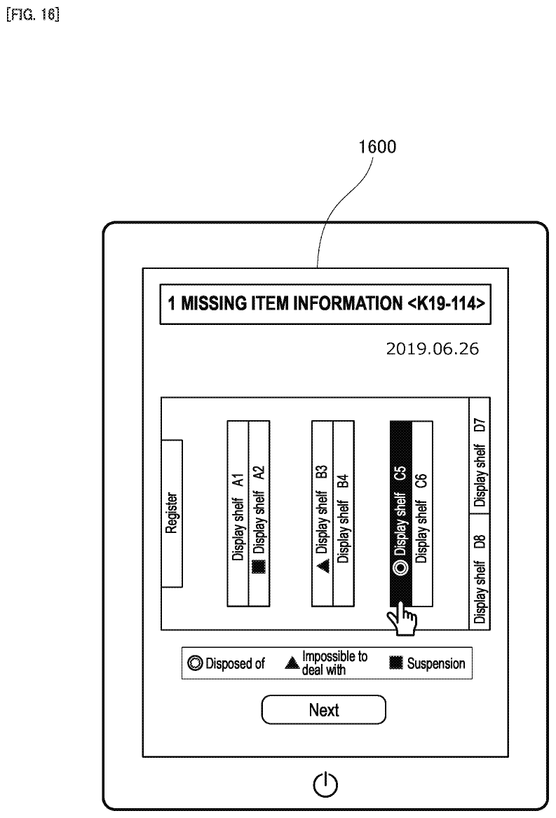

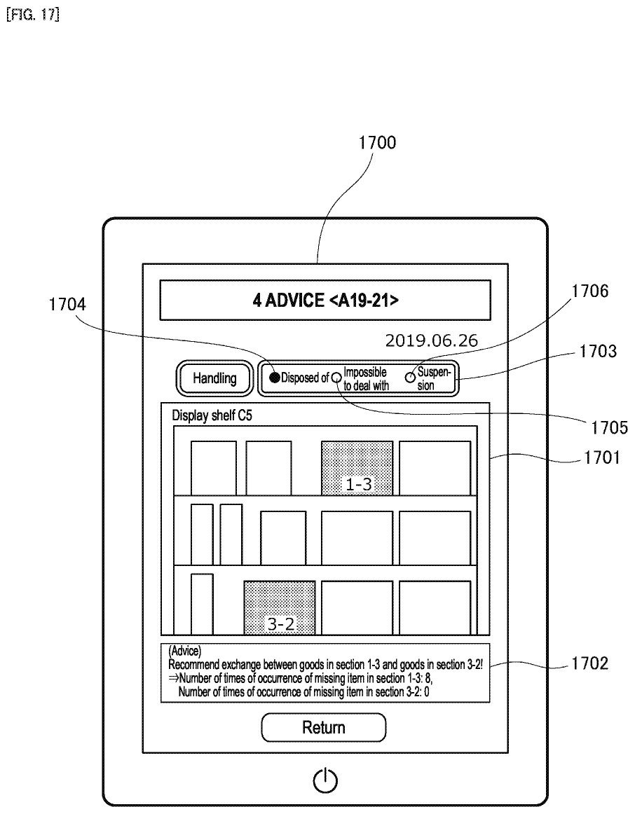

FIG. 16 shows an example shelf map UI relating to the shelf allocation advice service. FIG. 17 shows an example shelf allocation advice UI. When the shelf allocation advice service is selected from the service menu UI 910, the work assistance device 300 provides the terminal 400 with a shelf map UI 1600 as shown in FIG. 16. The shelf map UI 1600 is not described in detail here because it is approximately the same as the shelf map UI 1100 which was described above with reference to FIG. 11.

If the person in charge 2 selects, from the shelf map UI 1600, a display shelf 10 for which he or she wants to receive shelf allocation advice, as shown in FIG. 17 the work assistance device 300 provides the terminal 400 with a shelf allocation advice UI 1700 corresponding to the selected display shelf 10.

The shelf allocation advice UI 1700 has a display shelf region 1701, an advice region 1702, and a handling region 1703.

Current shelf allocation of the selected display shelf and information indicating an advice target section 30 are displayed in the display shelf region 1701.

The content of advice about the advice target section 30 is displayed in the advice region 1702. For example, as shown in FIG. 17, a sentence(s) that recommends exchange between goods in an advice target section 1-3 and goods in a section 3-2 is displayed in the advice region 1702. A reason for the advice may also be displayed in the advice region 1702. For example, as shown in FIG. 17, a sentence meaning that the number of times of occurrence of a missing item is 8 in the case of the section 1-3 and 0 in the case of the section 3-2 is displayed in the advice region 1702.

Buttons for selecting an action to be taken in response to advice are displayed in the handling region 1703. For example, as shown in FIG. 17, a “disposed of” button 1704, an “impossible to deal with” button 1705, and a “suspension” button 1706 are displayed in the handling region 1703. If an action has already been taken in response to the advice, the person in charge 2 may select the “disposed of” button 1704. If it is impossible to take any action in response to the advice, the person in charge 2 may select the “impossible to deal with” button 1705. If the person in charge 2 does not want to react to the advice at present, he or she may select the “suspension” button 1706. The work assistance device 300 records information indicating the action corresponding to the selected button as shelf allocation advice handling history.

The work assistance device 300 may generate shelf allocation advice based on the shelf allocation information and the missing item history information. For example, the work assistance device 300 may generate advice to exchange between a section 30 of an item that was rendered missing b₁ times or more and a section 30 of an item that was rendered missing less than b₂ times, where b₁ and b₂ are integers that are larger than or equal to 1 and satisfy a relationship b₁>b₂. This is because an item that is rendered missing frequently is considered a popular item and would be sold sufficiently even if its display section 30 (i.e., shelf allocation) is changed and an item that is not rendered missing frequently is not considered known well and could be increased in the number of sales by changing its display section 30 (i.e., shelf allocation).

An advice ID for identification of advice may be displayed in the shelf allocation advice UI 1700. “A19-21” shown in FIG. 17 is an example display of an advice ID.

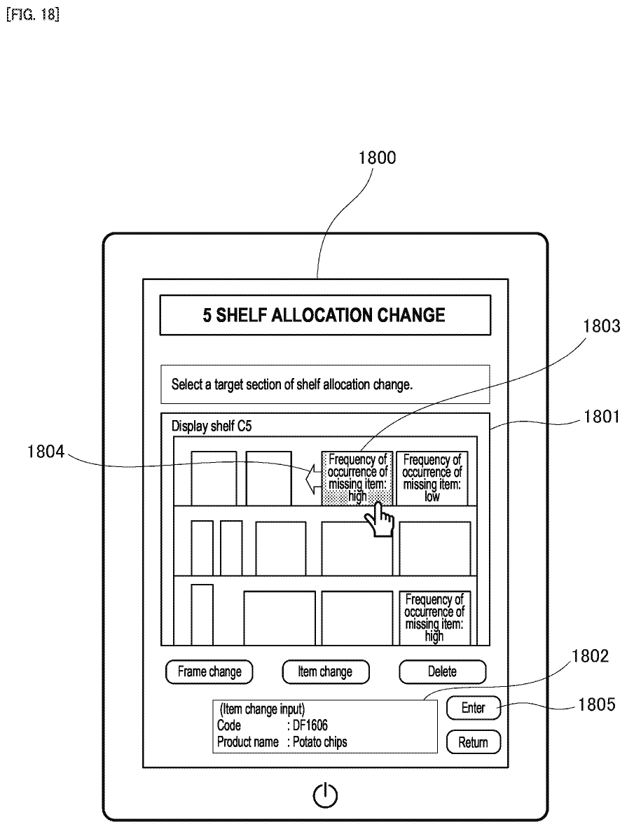

A button (not shown) for making a transition to a shelf allocation UI (see FIG. 18) for changing the shelf allocation of the display shelf 10 being displayed in the shelf allocation advice UI 1700.

The person in charge 2 can recognize a manner of shelf allocation that may increase a sales result by utilizing the shelf allocation advice service.

### <Shelf Allocation Change Service>

FIG. 18 shows an example shelf allocation change UI. When the shelf allocation change service is selected from the service menu UI 910, the work assistance device 300 provides the terminal 400 with a shelf allocation change UI 1800 shown in FIG. 18.

The shelf allocation change UI 1800 has a shelf region 1801 and an item input region 1802.

A current shelf allocation sections 30 are displayed in the shelf region 1801. The person in charge 2 can, for example, expand or reduce each section 30 or exchange sections 30 in the shelf region 1801 by manipulating it or them. For example, the person in charge 2 can expand a section 1803 by selecting it and sliding its left side in the direction of an arrow 1804.

Product information of goods to be displayed in a section 30 is input to a product information input region 1802. If the person in charge 2 selects a section 30 and inputs product information of goods to be displayed in a section 30 to the product information input region 1802, the work assistance device 300 updates the shelf allocation information so that the product information that has been input to the product information input region 1802 is correlated with the selected section 30. The person in charge 2 may input product information to the product information input region 1802 manually. Alternatively, the person in charge 2 may input product information to the product information input region 1802 by reading a bar code (or QR code (registered trademark)) attached to a merchandise with a camera.

When an enter button 1805 is pushed, the work assistance device 300 updates the shelf allocation information based on the section 30 changed and/or the product information.

Recommendable shelf allocation sections 30 may be displayed in the shelf region 1801 in place of the current shelf allocation sections 30. For example, the work assistance device 300 determines recommendable shelf allocation sections 30 based on the shelf allocation information and the missing item history information in the same manner as in the case of shelf allocation advice (described above).

The person in charge 2 can inform the work assistance device 300 of a shelf allocation change(s) easily by utilizing the shelf allocation change service.

### <Price Change Service>

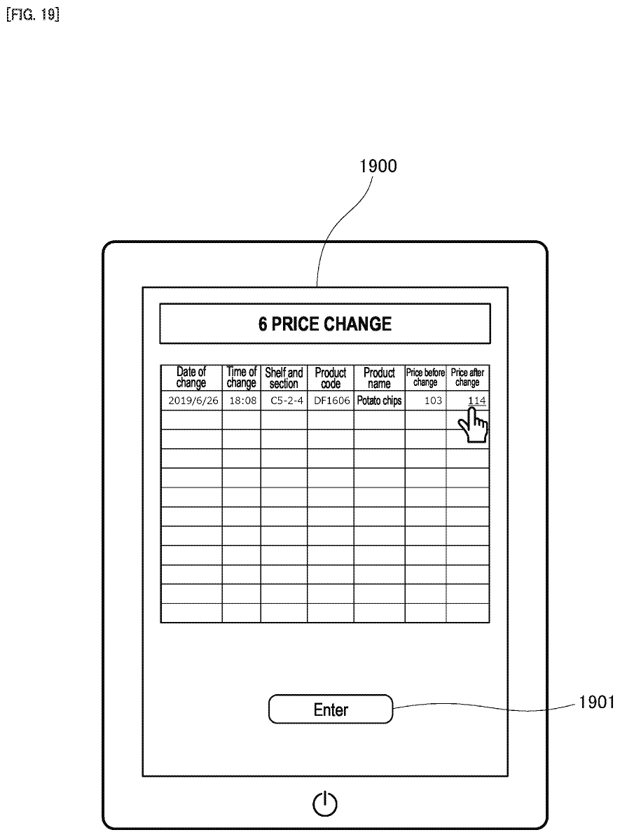

FIG. 19 shows an example price change UI. When the price change service is selected from the service menu UI 910, the work assistance device 300 provides the terminal 400 with a price change UI 1900 shown in FIG. 19.

A price change date, a price change time, pieces of identification information of a display shelf 10 and a section 30 in which goods are displayed, a product code, a product name, and prices before and after the price change of each item whose price has been changed are displayed in the price change UI 1900.

A price after a price change may be determined by the work assistance device 300. Alternatively, the person in charge 2 may be allowed to change a changed price determined by the work assistance device 300 by selecting the changed price from the price change UI 1900.

When an enter button 1805 is pushed, the work assistance device 300 stores the price after the change as part of the price information. Furthermore, when the enter button 1805 is pushed, the work assistance device 300 updates the display price of the shelf tag 20 to the price after the change. The work assistance device 300 may change the price of an item when its section 30 is changed.

The person in charge 2 can change the display price of a shelf tag 20 attached to a display shelf 10 by utilizing the price change service.

### <Modifications of Work Assistance Service>

The work assistance device 300 may provide the terminal 400 with information indicating the degree of missing of each item in a store and/or an area specified by the person in charge 2. The work assistance device 300 may provide the terminal 400 with information indicating the degree of missing of each item in every store.

### <Method for Setting Sections of Display Shelf Automatically>

Next, an example method for setting sections 30 automatically in the missing item detection device 200 will be described.

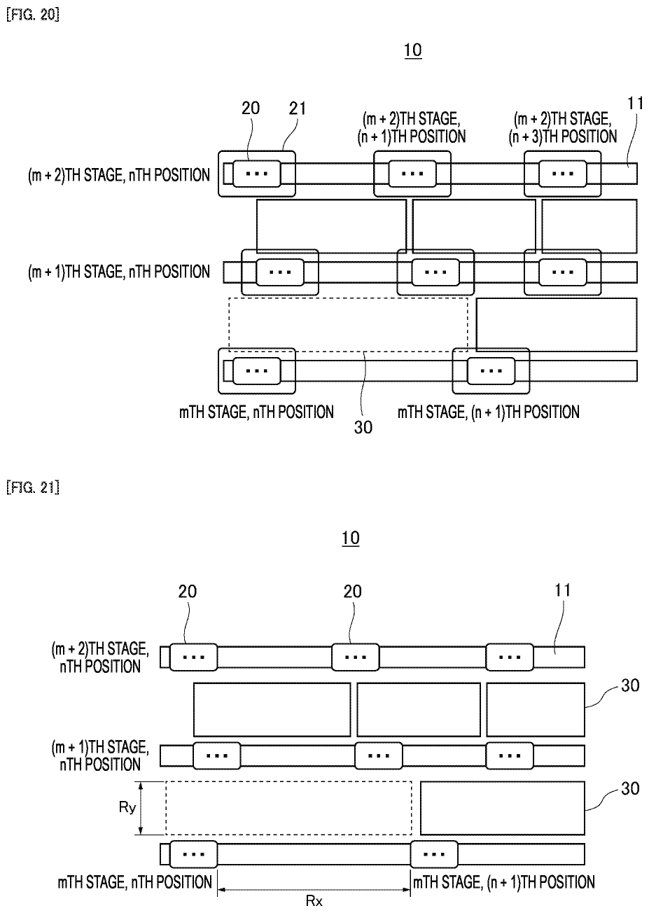

FIG. 20 is a diagram for explaining one example method for detecting shelf tags 20.

For example, the missing item detection device 200 detects shelf tags 20 that are located at an nth position and an (n+1)th position from the left end and are attached to a shelf plate 11 located at an mth stage from the bottom. Likewise, the missing item detection device 200 detects shelf tags 20 that are located at an nth position, an (n+1)th position, and an (n+2)th position from the left end and are attached to a shelf plate 11 located at an (m+1)th stage from the bottom. Likewise, the missing item detection device 200 detects shelf tags 20 that are located at an nth position, an (n+1)th position, and an (n+2)th position from the left end and are attached to a shelf plate 11 located at an (m+2)th stage from the bottom. Symbols m and n are integers that are larger than or equal to 1. In this manner, the missing item detection device 200 may detect shelf tags 20 left to right for each shelf stage. The left-to-right detection is just an example and the missing item detection device 200 may detect shelf tags 20 right to left.

FIG. 21 is a diagram for explaining one example method for setting sections 30.

The missing item detection device 200 sets a section 30 corresponding to a shelf tag 20 based on the positions of the shelf tags detected above. For example, where an mth-stage, nth-position shelf tag 20 corresponding to common goods is attached on the bottom left of a section 30 in which these goods are displayed, the missing item detection device 200 performs the following processing. That is, the missing item detection device 200 employs, as the width of a section 30, a width Rx from the position of the mth-stage, nth-position shelf tag 20 to the position of the mth-stage, (n+1)th-position shelf tag 20 (i.e., located immediately on the right of the former) and employs, as the height of the section 30, a height Ry from the position of the mth-stage, nth-position shelf tag 20 to the position of the (m+1)th-stage, nth-position shelf tag 20 (i.e., located immediately above the former). The missing item detection device 200 correlates the thus-set section 30 with the mth-stage, nth-position shelf tag 20.

In the above-described manner, the missing item detection device 200 can set the section 30 corresponding to an mth-stage, nth-position shelf tag 20 automatically.

The method for setting a section 30 of a display shelf 30 automatically is not limited to the above-described method. For example, the missing item detection device 200 may correlate a section 30 located below a shelf tag 20 with the shelf tag 20. The missing item detection device 200 may employ a prescribed width Rx centered by a shelf tag 20 as the width of a section 30. The missing item detection device 200 may set, as sections 30, respective divisional spaces obtained by dividing a display space 12 equally. Alternatively, the missing item detection device 200 may set sections 30 based on partitioning plates that exist physically in a display space 12. As a further alternative, the work assistance device 300 may determine sections 30 of a display shelf 10 including goods to be displayed and provide that information to the terminal 400 before display of the goods. When it is desired to change sections 30 etc.

for a store-side reason, instructions may be issued through the above-described shelf allocation change UI 1800 shown in FIG. 18.

### <Modification>

The functions of the missing item detection device 200 may be included in the work assistance device 300. In this case, the work assistance device 300 may receive a captured image(s) from the camera device 100 over the communication network 3 and set sections 30 of each display shelf 10, generate shelf allocation information 210, detect a missing item, and perform other operations in the same manners as with the above-described missing item detection device 200.

### <Summary of Present Disclosure>

The work assistance device 300 according to the disclosure is equipped with the receiving unit 303B which receives, from the missing item detection device 200 which detects an item-missing shelf that is a display shelf 10 in which a missing item has occurred based on a captured image of a display shelf 10 for goods, information relating to the item-missing shelf; the processing unit 301 which determines a position of the item-missing shelf based on the information relating to the item-missing shelf and shelf map information indicating an arrangement of the display shelfs 10 and generates work assistance information including information indicating the position of the item-missing shelf; and the transmission unit 303A which transmits the work assistance information to the terminal 400. With this configuration, the terminal 400 can display the information indicating the position of the item-missing shelf. Thus, the person in charge 2 can recognize the position of the item-missing shelf through the terminal 400, whereby his or her work relating to the missing item can be improved in efficiency.

The processing unit 301 may include, in the work assistance information, information that allows the terminal 400 to display the item-missing shelf in a different manner than the other display shelfs 10. This measure allows the terminal 400 to display the item-missing shelf in a different manner than the other display shelfs 10. Thus, the person in charge 2 can recognize the item-missing shelf visually through the terminal 400, whereby his or her work relating to the missing item can be improved in efficiency.

The receiving unit 303B may receive information that has been input to the terminal 400 and indicates how to deal with the item-missing shelf, and the processing unit 301 may include, in the work assistance information, the information indicating how the item-missing shelf is being dealt with. This measure allows the terminal 400 to display the information indicating how the item-missing shelf is being dealt with. Thus, the person in charge 2 can recognize visually how the item-missing shelf is being dealt with through the terminal 400, whereby his or her work relating to the missing item can be improved in efficiency.

The processing unit 301 may include, in the work assistance information, information relating to the missing item and information relating to stock of the missing item. This measure allows the terminal 400 to display the information relating to the missing item and the information relating to stock of the missing item. Thus, the person in charge 2 can recognize the information relating to the missing item and the information relating to stock of the missing item through the terminal 400, whereby his or her work relating to the missing item can be improved in efficiency.

The processing unit 301 may determine the degree of emergency of replenishment of the missing item based on information indicating a state of stock of the missing item and include information indicating the degree of emergency in the work assistance information. This measure allows the terminal 400 to display the degree of emergency of replenishment of the missing item. Thus, the person in charge 2 can recognize the degree of emergency of replenishment of the missing item through the terminal 400, whereby his or her work relating to the missing item can be improved in efficiency.

The information relating to the item-missing shelf may include identification information of an item-missing section, detected by the missing item detection device 200 as a section 30 where the missing item has occurred, of the item-missing shelf. The processing unit 301 may include, in the work assistance information, information that allows the terminal 400 to display the item-missing section in a different manner than the other sections. This measure allows the terminal 400 to display the item-missing section in a different manner than the other sections 30. Thus, the person in charge 2 can recognize the item-missing section visually through the terminal 400, whereby his or her work relating to the missing item can be improved in efficiency.

The processing unit 301 may generate information relating to how to change the sections 30 based on history information relating to missing items that occurred in the sections 30. This measure allows the terminal 400 to display the information relating to how to change the sections 30 (e.g., shelf allocation advice information). Thus, the person in charge 2 can recognize more appropriate changes to the sections 30, whereby his or her work relating to the shelf allocation can be improved in efficiency.

Although the embodiment has been described above with reference to the drawings, it goes without saying that the invention is not limited to this example. It is apparent that those skilled in the art could conceive various changes, modifications, replacements, additions, deletions, or equivalents within the confines of the claims, and they are construed as being included in the technical scope of the disclosure. Constituent elements of the above-described embodiments can be combined in a desired manner without departing from the spirit and scope of the invention.

Although the various embodiments have been described above with reference to the drawings, it goes without saying that the invention is not limited to these examples. It is apparent that those skilled in the art could conceive various changes or modifications within the confines of the claims, and they are naturally construed as being included in the technical scope of the invention. Constituent elements of the above-described embodiments can be combined in a desired manner without departing from the spirit and scope of the invention.

The present application is based on Japanese Patent Application No. 2019-156932 filed on Aug. 29, 2019, the disclosure of which is invoked in this application by reference.

### INDUSTRIAL APPLICABILITY

The disclosure is suitable for systems for assisting work relating to a missing item of goods.

### DESCRIPTION OF SYMBOLS

10: Display shelf
11: Shelf plate
12: Display space
20: Shelf tag
30: Section
100: Camera device
200: Missing item detection device
201: Processing unit
202: Memory
203: Communication unit
204: Storage
205: Internal bus
210: Shelf allocation information
300: Work assistance device
301: Processing unit
302: Memory
303: Communication unit
304: Storage
305: Internal bus
310: Management information
400: Terminal
401: Processing unit
402: Memory
403: Communication unit
404: Input unit
405: Display unit
406: Storage
407: Internal bus
900: Login UI
910: Service menu UI
1000: Missing item information UI
1100: Shelf map UI
1200: Display shelf UI
1300: Shelf map UI
1400: Display shelf UI
1500: Order history UI
1600: Shelf map UI
1700: Shelf allocation advice UI
1800: Shelf allocation change UI
1900: Price change UI

1. A work assistance system comprising:
a camera device that captures a display shelf for goods and that generates a captured image;
a missing item detection device that detects an item-missing shelf which is a display shelf where a missing item has occurred based on the captured image, and that generates identification information of the item-missing shelf; and
a work assistance device that determines a position of the item-missing shelf based on the identification information of the item-missing shelf unit and shelf map information indicating an arrangement of the display shelf, and that transmits work assistance information including information indicating the position of the item-missing shelf unit to a terminal.

2. A work assistance device comprising:
a receiving unit that receives, from a missing item detection device which detects an item-missing shelf which is a display shelf where a missing item has occurred based on a captured image of a display shelf for goods, information relating to the item-missing shelf unit;
a processing unit that determines a position of the item-missing shelf based on the information relating to the item-missing shelf and shelf map information indicating an arrangement of the display shelf, and that generates work assistance information including information indicating the position of the item-missing shelf; and
a transmission unit that transmits the work assistance information to a terminal.

3. The work assistance device according to claim 2, wherein the processing unit includes, in the work assistance information, information that allows the terminal to display the item-missing shelf in a different manner than the other display shelf.

4. The work assistance device according to claim 3, wherein:
the receiving unit receives information that has been input to the terminal and that indicates how to deal with the item-missing shelf; and
the processing unit includes, in the work assistance information, the information indicating how the item-missing shelf is being dealt with.

5. The work assistance device according to claim 2, wherein the processing unit includes, in the work assistance information, information relating to the missing item and information relating to stock of the missing item.

6. The work assistance device according to claim 5, wherein the processing unit determines degree of emergency of replenishment of the missing item based on information indicating a state of stock of the missing item and includes information indicating the degree of emergency in the work assistance information.

7. The work assistance device according to claim 2, wherein:
the information relating to the item-missing shelf includes identification information of an item-missing section, detected by the missing item detection device as a section where the missing item has occurred, of the item-missing shelf; and
the processing unit includes, in the work assistance information, information that allows the terminal to display the item-missing section in a different manner than the other section.

8. The work assistance device according to claim 7, wherein the processing unit generates information relating to change of the section based on history information relating to a missing item that occurred in the section.

9-14. (canceled)

15. A work assistance device comprising:
a receiving unit that receives, from a missing item detection device which detects a shelf which requires replenishment of goods based on a captured image of a display shelf for goods, information relating to the shelf which requires replenishment of goods;
a processing unit that determines a position of the shelf which requires replenishment of goods based on information relating to the shelf which requires replenishment of goods and shelf arrangement information indicating an arrangement of the shelf which requires replenishment, and that generates work assistance information including information indicating the position of the shelf which requires replenishment of goods; and
a transmission unit that transmits the work assistance information to a terminal.

16. The work assistance device according to claim 15, wherein the processing unit includes, in the work assistance information, information that allows the terminal to display the shelf which requires replenishment of goods in a different manner than the other display shelf.

17. The work assistance device according to claim 16, wherein:
the receiving unit receives information which has been input to the terminal and indicates how to deal with the shelf which requires replenishment of goods; and
the processing unit includes, in the work assistance information, the information indicating how to deal with the shelf which requires replenishment of goods.

18. The work assistance device according to claim 15, wherein the processing unit includes, in the work assistance information, information relating to the item which requires replenishment and information relating to stock of the item which requires replenishment.

19. The work assistance device according to claim 18, wherein the processing unit determines degree of emergency of replenishment of the item which requires replenishment based on information indicating a state of stock of the missing item which requires replenishment and includes information indicating the degree of emergency in the work assistance information.

20. The work assistance device according to claim 15, wherein:
the information relating to the shelf which requires replenishment of goods includes identification information of a replenishment target section detected by the missing item detection device as a section which requires replenishment of goods of the shelf which requires replenishment of goods; and
the processing unit includes, in the work assistance information, information that allows the terminal to display the replenishment target section in a different manner than the other section.

21. The work assistance device according to claim 20, wherein the processing unit generates information relating to change of the section based on history information relating to replenishment of the section.

22-26. (canceled)
